(19) United States
(12) Patent Application Publication
(10) Pub. No.: US 2005/0091395 A1
(43) Pub. Date: Apr. 28, 2005

(54) Method and system for transferring data files

(76) Inventors: Jason Harris, Mountain View, CA (US); Chia-Hsin Li, San Jose, CA (US); Ronald Boskovic, Campbell, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/681,521

(22) Filed: Oct. 8, 2003

(51) Int. Cl. G06F 15/16

(52) U.S. Cl. 709/232

(57) ABSTRACT

A method and a system for transferring a data file between a first and a second computing device are provided. A wait time is calculated based on a transfer rate provided by the first computing device. Thereafter, the second computing device transfers a first portion of the data file to the first computing device. Next, the second computing device waits for the wait time before transferring a second portion of the data file to the first computing device.

### BACKGROUND OF THE INVENTION

1. Field of the Invention

The present invention relates to data transfer and, more particularly, to a method and a system for transferring data files between communicating computing devices, e.g., a client and a server.

2. Description of the Related Art

The explosive growth of the Internet has fueled the demand for Internet-connected computing devices such as personal digital assistants and cell phones. Initially, these devices were limited in functionality; the devices could transfer and receive simple text messages, as well as browse special text-only web sites. Over the years, these devices have become much more complex and are able to perform tasks that once required the computing power previously only available with a much larger desktop computer. For example, these devices now have the ability to perform video conferencing whereby the devices are used to facilitate communication between two or more participants physically located at separate locations. However, the devices that perform video conferencing need to exchange live video, audio, and other data to view, hear, or otherwise collaborate with each participant. Since video, audio, drawings, etc. typically consist of a large amount of data, the devices must be able to receive a large amount of data.

Several factors need to be considered when transferring large data files over a network to the devices. For example, the speed of the network affects the maximum rate at which data files can be sent. The speed of the network is typically measured in terms of bandwidth. If several processes are transferring or receiving large data files over the network, there is less network bandwidth left for new processes to transfer or receive data files. As a result, the rate at which these new processes can transfer data files is reduced.

Additionally, these devices typically have limited power, memory, and computing capability because of their small size and portable nature. Since the devices are limited in their computing power, processing large data files transferred from a server may dominate the central processing unit (CPU) cycles of the devices. Furthermore, as these devices tend not to handle multithreading effectively, these devices usually fail when they receive large amounts of data files on a single thread that the CPU cannot adequately process, as the thread will dominate the CPU's time. Consequently, if the devices cannot process the data files fast enough, the devices may lose incoming data. In this case, the devices must request that the data files be resent, thereby wasting network bandwidth through inefficient transfers.

As a result, there is a need to provide a method and a system for regulating the transfer of data files in order to more efficiently utilize available network bandwidth and to transfer the data files to the devices at a suitable rate for the devices.

### SUMMARY OF THE INVENTION

Broadly speaking, the present invention fills these needs by providing a system and a method to transfer data files between computing devices. It should be appreciated that the present invention can be implemented in numerous ways, including as a process, an apparatus, a system, computer readable media, or a device. Several inventive embodiments of the present invention are described below.

One embodiment provides a method for transferring a data file between a first and a second computing device. A wait time is calculated based on a transfer rate provided by the first computing device. Next, the second computing device transfers a first portion of the data file to the first computing device. Thereafter, the second computing device waits for the wait time before transferring a second portion of the data file to the first computing device.

Another embodiment provides a computer readable medium having program instructions for transferring a data file between a first and a second computing device. The computer readable medium provides program instructions for calculating a wait time based on a transfer rate provided by the first computing device and program instructions for transferring a first portion of the data file from the second computing device to the first computing device. Thereafter, the computer readable medium provides program instructions for waiting for the wait time before transferring a second portion of the data file to the first computing device.

In still another embodiment provides a system for transferring data files between computing devices. The system provides a first computing device configured to determine a transfer rate and a second computing device configured to regulate a transfer rate provided by the first computing device. The second computing device includes a transmission regulation circuitry configured to calculate a wait time defined from both a portion of the data files being transferred between the first computing device and the second computing device and the transfer rate.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 illustrates a simplified block diagram of a server in communication with a client through a network, in accordance with one embodiment of the present invention.

FIG. 2 is a flowchart diagram illustrating the method operations for transferring a data file between a client and a server, in accordance with one embodiment of the present invention.

FIG. 3 is a simplified schematic diagram illustrating the wait time inserted between data portions during data transmission, in accordance with one embodiment of the present invention.

FIG. 4 is a flowchart diagram illustrating the method operations for processing a request from a client and transferring a data file to the client, in accordance with one embodiment of the present invention.

FIG. 5 is an alternative embodiment to the flowchart of FIG. 4.

### DETAILED DESCRIPTION OF THE EXEMPLARY EMBODIMENTS

An invention is described for a method and a system for transferring data files between computing devices. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

The embodiments described herein provide a method and a system that transfers a data file to a client at a transfer rate provided by the client. In one embodiment, the client determines the transfer rate. It should be appreciated that because the client is in the position to most efficiently determine the optimal transfer rate for the hardware/software component configuration of the client. The transfer rate is communicated to a server. The server then processes the request to provide the client with data files transferred at a suitable transfer rate. The processing of the request by the server includes determining whether to calculate a wait time. As will be explained in more detail below, the wait time is calculated by manipulating a block size associated with the transmission protocol in conjunction with the transfer rate. The calculated wait time is then used to regulate the transmission of the blocks of data to the client. It should be noted that the terms “transfer” and “transmit” are the same and can be used interchangeably.

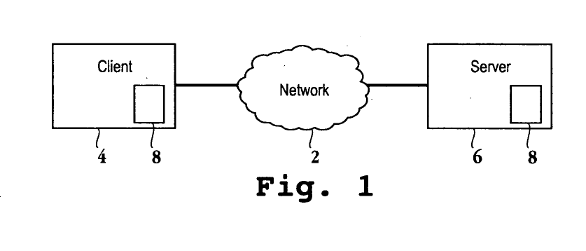

FIG. 1 illustrates a simplified block diagram of server 6 in communication with client 4 through network 2, in accordance with one embodiment of the present invention. Server 6 and client 4 can include any suitable type of computing device. For example, the computing device can include a computer system based on a microprocessor, a portable computing device, a personal digital assistant, a device controller, a cell phone, or a computational engine within an appliance.

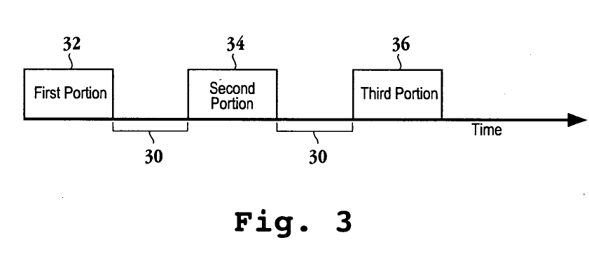

Server 6 and client 4 also contain transmission regulation circuitry 8 configured to regulate the transmission of blocks of data from the server to the client, and vice versa according to a wait time as described herein. One skilled in the art will appreciate that the functionality described for the transmission of data with reference to FIGS. 3-5 may be incorporated into a microprocessor or integrated circuit. This incorporated circuitry is referred to as transmission regulation circuitry and may be incorporated into either the client or the server. For example, the functionality may be provided through an adapter card, or the like, having a circuitry configured to perform the above-described functionality. It will be apparent to one skilled in the art that the functionality described herein may be synthesized into firmware through a suitable hardware description language (HDL). For example, the HDL, e.g., VERILOG, may be employed to synthesize the firmware and the layout of the logic gates for providing the necessary functionality described herein to provide a hardware implementation of the data file transferring techniques and associated functionalities. Thus, the embodiments described herein may be captured in any suitable form or format that accomplishes the functionality described herein and is not limited to a particular form or format.

Generally speaking, network 2 can include any type of wire or wireless communication channel capable of linking together computing nodes (e.g., a local network, a wide area network, an open and modular development environment (EDMA) network, global systems for mobile communications (GSM) network, cable connection, etc.). Furthermore, server 6 and client 4 can communicate using any appropriate communication format (e.g., Transmission Control Protocol/Internet Protocol (TCP/IP), HyperText Transfer Protocol (HTTP), User Datagram Protocol (UDP), File Transfer Protocol (FTP), Simple Mail Transfer Protocol (SMTP), etc.).

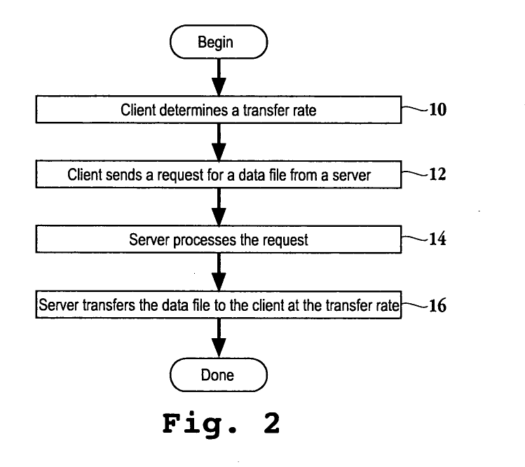

FIG. 2 is a flowchart diagram illustrating the method operations for transferring a data file between a client and a server, in accordance with one embodiment of the present invention. Starting in operation 10, before the client requests the data file from the server, the client determines a suitable transfer rate at which the client would receive the data file from the server, in accordance with one embodiment of the present invention. The transfer rate can be based on a combination of the client's processor power availability, network bandwidth availability (i.e., the speed at which the client can transmit and receive data files), memory availability, and any additional factors that would affect the performance of the client. In one embodiment, the transfer rate is a maximum transfer rate at which the client can receive the data file from the server. However, a network may not support the maximum transfer rate or the server cannot transfer the data file at the maximum transfer rate. In this case, the transfer rate is less than the maximum transfer rate at which the client can receive the data file from the server, in accordance with another embodiment of the present invention.

Alternatively, the server determines the transfer rate. Here, the client sends transfer rate parameters (i.e., processor power availability, network bandwidth availability, memory availability, etc.) to the server and the server determines the transfer rate based on the transfer rate parameters received from the client.

Subsequently, in operation 12, the client sends a request to the server to transfer the data file and, in one embodiment, also sends the transfer rate to the server. It should be appreciated that where the server determines the transfer rate, the client may send transfer rate parameters for the server to determine the transfer rate instead. Although FIG. 2 shows that the client determines the transfer rate before sending the request, this is not meant to be limiting, as the client can also send the transfer rate to the server after the client sends the request, in accordance with another embodiment of the present invention. Thereafter, in operation 14, the server receives the request from the client and processes the request. In response to the client's request, the server transfers the data file to the client at the transfer rate in operation 16.

FIG. 3 is a simplified schematic diagram illustrating the wait time inserted between data portions during data transmission, in accordance with one embodiment of the present invention. The server divides the data file into portions, like portions 32, 34, and 36, and transfers each portion periodically with wait time 30 between each transfer until all portions are transferred to the client. For example, after the server transfers first portion 32 to the client, the server waits for wait time 30 before transferring second portion 34. After the server transfers second portion 34, the server waits again for wait time 30 before transferring third portion 36, and so on.

As illustrated in FIG. 3, the data file is divided into three equal portions 32, 34, and 36. Portions 32, 34, and 36 can be in any suitable size (i.e., block size) and in any suitable unit of data. In one embodiment, the block size is a packet size of a TCP/IP protocol. In another embodiment, the block size is a maximum transmission unit of 1500 bytes as is standard in most Ethernet networks. In another embodiment, portions 32, 34, and 36 are not in equal portions. In other words, the data file is not divided equally and the block sizes of each portion 32, 34, and 36 are not the same.

In one embodiment, wait time 30 is simply the portion of the data file divided by a transfer rate and the wait time can be in any time increment (e.g., milliseconds, seconds, minutes, etc.). In other words, wait time 30 is a number representing the block size of a portion that is transferred with each transmission burst divided by a number representing the transfer rate. In mathematical terms, the relationship is represented by:

$$wait\_time = \frac{block\_size}{transfer\_rate}$$

For example, wait time (milliseconds)=1000*(block size (kilobits)/transfer rate (kilobits per second)), whereby multiplying by 1000 converts kilobits to bits. In another embodiment, a user arbitrarily specifies wait time 30. For example, the user may specify wait time 30 through a graphical user interface (GUI) on either the client or the server. Although wait time 30 between portions 32, 34, and 36 as illustrated in FIG. 3 are equal, the wait time between the respective portions can be different, in accordance with another embodiment of the present invention.

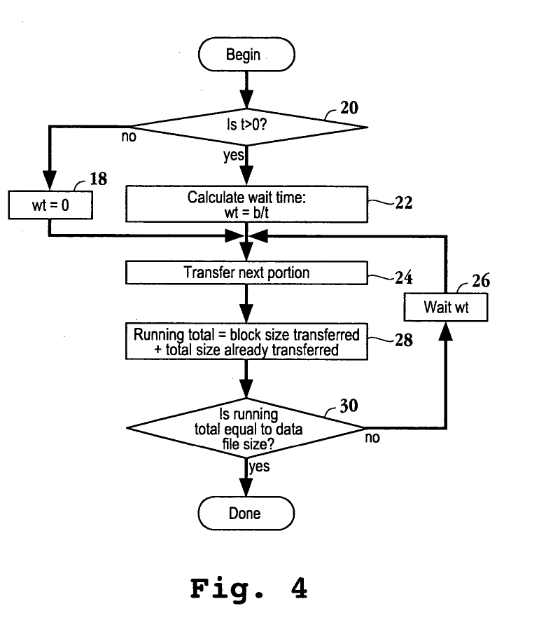

FIG. 4 is a flowchart diagram illustrating the method operations for processing a request from a client and transferring a data file to the client, in accordance with one embodiment of the present invention. Starting in operation 20, the server checks whether a transfer rate (t) is greater than zero. As discussed above, in one embodiment, the server receives the transfer rate from the client. In another embodiment, the server determines the transfer rate. As illustrated in operation 18, if the transfer rate is equal to or less than zero, then a wait time (wt) is zero. In one embodiment, the transfer rate of zero or less signals to the server to transfer the data file at the highest rate possible. In other words, the server does not wait after transferring each portion of the data file. Although the client typically transmits a zero transfer rate to signal the server to transmit at the highest possible rate, the server also accepts a negative transfer rate in case the client erroneously transmits a negative transfer rate.

On the other hand, if the transfer rate is greater than zero, the wait time is calculated in operation 22. As discussed above, the wait time is a portion of the data file with block size (b) divided by the transfer rate, in accordance with one embodiment of the present invention. Thereafter, in operation 24, the server writes a portion of the data file to a communication channel to be transferred to the client.

In operation 28, the server stores a running total of the block sizes transferred to the client in memory, in accordance with one embodiment of the present invention. The running total is calculated by adding the block size transferred to a total size already transferred. Thereafter, in operation 30, once the server transfers the portion, the server compares the running total with a size of the data file. If the running total is not equal to the size of the data file, the server waits for the wait time in operation 26 before transferring another portion in operation 24. In another embodiment, the server stores a running total of the total number of portions transferred to the client in memory. The running total is calculated by adding the number of portions transferred to a total number of portions already transferred. The server then compares the running total with a total number of portions in the data file. In short, this process of transferring portions and waiting for the wait time between each transfer repeats until the server transfers all the portions in the data file.

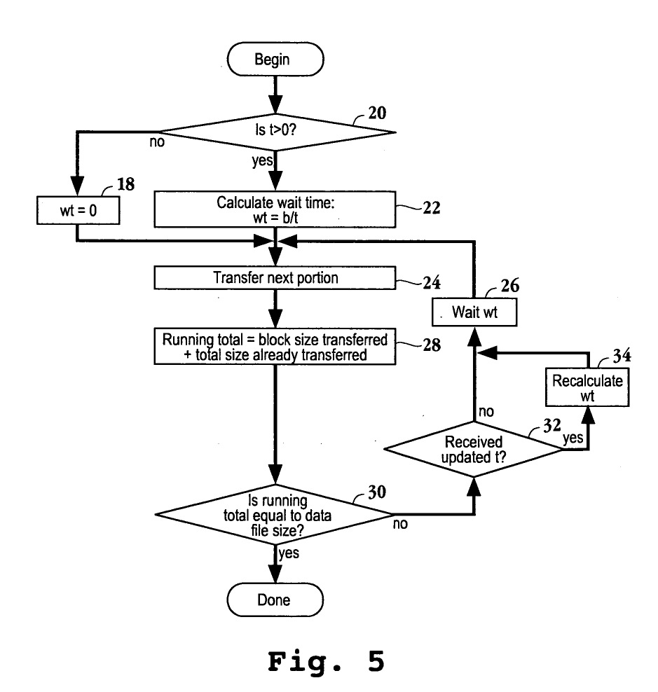

FIG. 5 is an alternative embodiment to the flowchart of FIG. 4. In this embodiment, the operations are similar to the operations disclosed in FIG. 4 with the exception of operation 30. At operation 30, a server compares a running total with a size of a data file. If the running total is not equal to the size of the data file, the server in operation 32 checks whether it has received an update of a transfer rate (t) or a transfer rate parameter. In one embodiment, a client automatically sends periodic updates of the transfer rate to the server. In another embodiment, the client sends the update of the transfer rate in response to a request by the server for the update. If there is no update of the transfer rate, the server in operation 26 waits for a previously calculated wait time before transferring another portion of the data file in operation 24. If there is an update, the server recalculates a wait time in operation 34 based on the update of the transfer rate, and the server, in operation 26, waits for the adjusted wait time before transferring another portion of the data file in operation 24.

In summary, the above described invention provides a method and a system to transfer a data file to a client at a transfer rate provided by the client. In order to transfer the data file to the client at the transfer rate, the server divides the data file into portions and transfers each portion to the client with a wait time inserted between the portions during the transfer. Thus, the wait time is used to regulate the transmission of data packets to a receiving device in order not to overwhelm the receiving device.

Basing the transfer rate on the client's limitations instead of network limitations enables the client to receive the data file at a transfer rate the client can handle. For instance, modulating the transfer rate is effective in a multi-thread environment to prevent one thread from dominating CPU's time. The problem of CPU dominating a thread tends to occur in clients with slow processors (e.g., personal digital assistants, cell phones, etc.) or in operating systems with poor multithread control. Without one thread dominating the CPU time, the CPU can allocate processing power to other threads, thereby not slowing down other concurrently running applications in the client. While the embodiments described above refer to a client server configuration, it should be appreciated that this for exemplary purposes only and not meant to be limiting. That is, the embodiments described herein may be applied to any suitable configuration where two computing devices are transferring data between each other.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A method for transferring a data file between a first and a second computing device, comprising:
calculating a wait time based on a transfer rate provided by the first computing device;
transferring a first portion of the data file from the second computing device to the first computing device; and
waiting for the wait time before transferring a second portion of the data file to the first computing device.

2. The method of claim 1, further comprising:
determining a size associated with the first portion and the second portion;
comparing the size associated with the first portion and the second portion to the size of the data file; and
if the size associated with the first portion and the second portion is less than a size of the data file, then the method includes waiting for the wait time prior to transferring a third portion of the data file to the first computing device.

3. The method of claim 2, wherein the method operation of determining the size associated with the first portion and the second portion includes,
adding a first size associated with the first portion to a second size associated with the second portion.

4. The method of claim 1, further comprising:
adjusting the wait time during the transfer based on periodic updates of the transfer rate provided by the first computing device.

5. The method of claim 1, further comprising:
dividing the data file into one of equal and unequal portions.

6. The method of claim 1, wherein the method operation of calculating the wait time includes,
dividing a value associated with a size associated with the first portion of the data file by the transfer rate.

7. The method of claim 1, wherein the method operation of calculating the wait time includes,
defining the wait time from both a size associated with the first portion of the data file and the transfer rate.

8. The method of claim 1, further comprising:
determining the transfer rate from transfer rate parameters selected from the group consisting of an amount of processor power availability of the client, an amount of network bandwidth availability, and an amount of memory availability of the client.

9. A computer readable medium having program instructions for transferring a data file between a first and a second computing device, comprising:
program instructions for calculating a wait time based on a transfer rate provided by the first computing device;
program instructions for transferring a first portion of the data file from the second computing device to the first computing device; and
program instructions for waiting for the wait time before transferring a second portion of the data file to the first computing device.

10. The computer readable medium of claim 9, further comprising:
program instructions for determining a size associated with the first portion and the second portion; and
if the size associated with the first portion and the second portion is less than a size of the data file, then the computer readable medium includes program instructions for waiting for the wait time prior to transferring a third portion of the data file to the first computing device.

11. The computer readable medium of claim 10, wherein the program instructions for determining the size associated with the first portion and the second portion includes, program instructions for adding a first size associated with the first portion to a second size associated with the second portion.

12. The computer readable medium of claim 9, further comprising:
program instructions for adjusting the wait time during the transfer based on periodic updates of the transfer rate provided by the first computing device.

13. The computer readable medium of claim 9, further comprising:
program instructions for dividing the data file into one of equal and unequal portions.

14. The computer readable medium of claim 9, wherein the program instructions for calculating the wait time includes,
program instructions for dividing a size associated with the first portion of the data file by the transfer rate.

15. The computer readable medium of claim 9, wherein the program instructions for calculating the wait time includes, program instructions for defining the wait time from both a size associated with the first portion of the data file and the transfer rate.

16. The computer readable medium of claim 9, further comprising:
program instructions for determining the transfer rate from transfer rate parameters selected from the group consisting of an amount of processor power availability of the client, an amount of network bandwidth availability, and an amount of memory availability of the client.

17. A system for transferring data files between computing devices, comprising:
a first computing device configured to determine a transfer rate; and
a second computing device configured to regulate a transfer rate provided by the first computing device, the second computing device including,
transmission regulation circuitry configured to calculate a wait time defined from both a block size of a portion of the data files being transferred between the first computing device and the second computing device and the transfer rate.

18. The system of claim 17, wherein the transmission regulation circuitry includes, logic for dividing the block size by the transfer rate to derive the wait time.

19. The system of claim 17, wherein the second computing device is configured to determine a running total of portions of the data files transferred to the first computing device; and
if the running total is less than a total size associated with the data files, then the second computing device is configured to wait for the wait time prior to transferring another portion of the data files to the first computing device.

20. The system of claim 19, wherein the second computing device is further configured to add sizes of the portions of the data files transferred to the first computing device.

21. The system of claim 17, wherein the second computing device is further configured to adjust the wait time during the transfer based on periodic updates of the transfer rate provided by the first computing device.

22. The system of claim 17, wherein the second computing device is further configured to divide the data files into one of equal portions and unequal portions for transmission to the first computing device.

23. The system of claim 17, wherein the first computing device is selected from the group consisting of, a laptop computer, a personal digital assistant, and a cell phone.

24. The system of claim 17, wherein the system is a video conferencing system.

25. The system of claim 17, wherein the transfer rate is determined from transfer rate parameters selected from the group consisting of an amount of processor power availability of the first computing device, an amount of network bandwidth availability, and an amount of memory availability of the first computing device.
